(19) United States
(12) Patent Application Publication
(10) Pub. No.: US 2017/0305019 A1
(43) Pub. Date: Oct. 26, 2017

(54) MANUAL WORK STATION AND CONTROL UNIT FOR CONTROLLING THE SEQUENCING OF A MANUAL WORK STATION

(71) Applicant: Robert Bosch GmbH, Stuttgart (DE)

(72) Inventors: Wolfgang Pomrehn, Ingersheim (DE); Andreas Frede, Stuttgart-Feuerbach (DE); Christoph Mueller, Ditzingen (DE); Marc Bindel, Waiblingen (DE); Uwe Dowedeit, Ebersbach-Buenzwangen (DE); Volker Hartmann, Lorch (DE)

(21) Appl. No.: 15/437,578

(22) Filed: Feb. 21, 2017

(30) Foreign Application Priority Data
Apr. 22, 2016 (DE) 102016206866.0
Apr. 22, 2016 (DE) 202016102142.1

(51) Int. Cl. B25J 19/06; B25J 9/16; B25J 13/08; B25J 19/02

(52) U.S. Cl. CPC B25J 19/06; B25J 19/021; B25J 9/1676; B25J 19/026; B25J 9/161; B25J 13/089; B25J 13/084; G05B 2219/40202; G05B 2219/40203

(57) ABSTRACT

A manual work station, in particular a manual work station for manufacturing and/or a manual work station for packaging, comprising a work area accessible to a worker, the manual work station having at least one robotic arm, the manual work station having a safety device, which is designed in such a way that the robotic arm cooperates in a contact-free manner with the worker in the work area. The invention furthermore relates to a control unit for controlling the sequencing of a manual work station.

### CROSS REFERENCE

The present application claims the benefit under 35 U.S.C. §119 of German Patent Application No. DE 102016206866.0 filed on Apr. 22, 2016, and German Patent Application No. DE 202016102142.1 filed on Apr. 22, 2016, which are each expressly incorporated herein by reference in its entirety.

### BACKGROUND INFORMATION

The present invention relates to a manual work station and to a control unit for controlling the sequencing of a manual work station.

German Patent Application No. DE 10 2012 011412 A1 describes a manual work station including a tool system, and a method for worker guidance. A worker guidance device is designed to indicate by a spot of light an assembly location on a workpiece that is to be worked on.

### SUMMARY

A manual work station in accordance with the present invention may have the advantage that the manual work station allows for a partially automated production, the manual work station according to the present invention combining the positive characteristics of a robot, such as precision, strength and endurance, in a particularly advantageous manner with the capabilities of a human being as a worker, such as dexterity and flexibility, directly in the same work area without a spatial separation of robot and worker.

The manual work station has a safety device, which is designed in such a way that the robotic arm and the worker cooperate in the work area. The safety device is preferably designed in such a way that the robot and the worker cooperate in a contact-free manner and/or in a collaborating manner in the work area. This has the advantage that the cooperation is safe for the worker and that there is no risk of injury.

It is advantageous if the work surface is vertically adjustable since this allows for an adaptation to different workers. This contributes toward creating an ergonomic work environment. This leads to particularly high-quality work results.

It is particularly advantageous if the robotic arm is covered with distance sensors and that the distance sensors interact with the safety device in such a way that the safety device effects a reduction in movement of the robotic arm when the robotic arm approaches an object. This allows for the worker and the robot to work together in the same work area while avoiding risks of accidents for the worker.

The equipment of the manual work station with at least one monitoring sensor, for example a camera and/or a laser scanner, has the advantage of avoiding errors in that results are monitored by the monitoring sensor. It is particularly advantageous if the monitoring sensor makes it possible to detect the successful completion of intermediary steps in a chain of assembly steps and that the next assembly step of the worker on the product to be produced may be interactively displayed by a projector. This contributes to a particularly high quality of the produced products while at the same time reducing the reject rate.

The fact that the manual work station has at least one projector makes it possible to carry out interactive learning programs for new products or new employees. Furthermore, the use of the projector supports disabled or older workers in performing interactive pause cycles or rehabilitative exercises in that this information is displayed via the projector and/or a screen. The projector furthermore makes it possible to display service and maintenance information or to run through interactive service programs. This also contributes advantageously to a high quality of the manufactured products. Particularly advantageously, adaptations of work cycles that become necessary as a result of product changes may be performed automatically, for example by displaying instructions.

The development of at least one part of the work surface as a top light projection surface has the advantage that the displays projected by the projector have a high contrast and are therefore particularly well visible for the worker.

It is particularly advantageous that the manual work station may be adjusted to the worker in that the reading device reads codes.

The display of at least one operating state of the manual work station by an optical display unit has the advantage that the operating state of the manual work station may be recognized from outside in an easy and intuitive manner. Downtimes are consequently reduced as failures may be quickly recognized and thus remedied.

A control unit for controlling the sequencing of a manual work station, in particular the described manual work station, is particularly advantageous, the control unit including a safety device and/or interacting with a safety device, the safety device effecting a contact-free cooperation of a robotic arm of the manual work station with a worker in a work area of the manual work station. The advantages described in relation to the manual work station also apply accordingly to the control unit. The control unit preferably comprises a processor including a memory, as well as input and output interfaces. The sequencing program is stored in the memory as program code.

Further advantages are yielded by the description of exemplary embodiments below with reference to the figures.

### BRIEF DESCRIPTION OF THE DRAWINGS

Exemplary embodiments of the present invention are represented in the figures and are explained in more detail in the description below, identical reference symbols designating identical elements and parts in the figures.

FIG. 1 shows a general view of a manual work station.

FIG. 2 shows a block diagram of an interactive manual work station.

FIG. 3 shows a block diagram of an automatically personalized manual work station.

FIG. 4 shows a block diagram of a manual work station for packaging.

### DETAILED DESCRIPTION OF EXAMPLE EMBODIMENTS

A manual work station, in particular a manual work station for manufacturing and/or a manual work station for packaging, is described below. The manual work station comprises a work area accessible to a worker, the manual work station having at least one robotic arm, the manual work station having a safety device that is designed in such a way that the robotic arm and the worker cooperate in the work area in contact-free fashion. Furthermore, a control unit is described for controlling the sequencing of a manual work station.

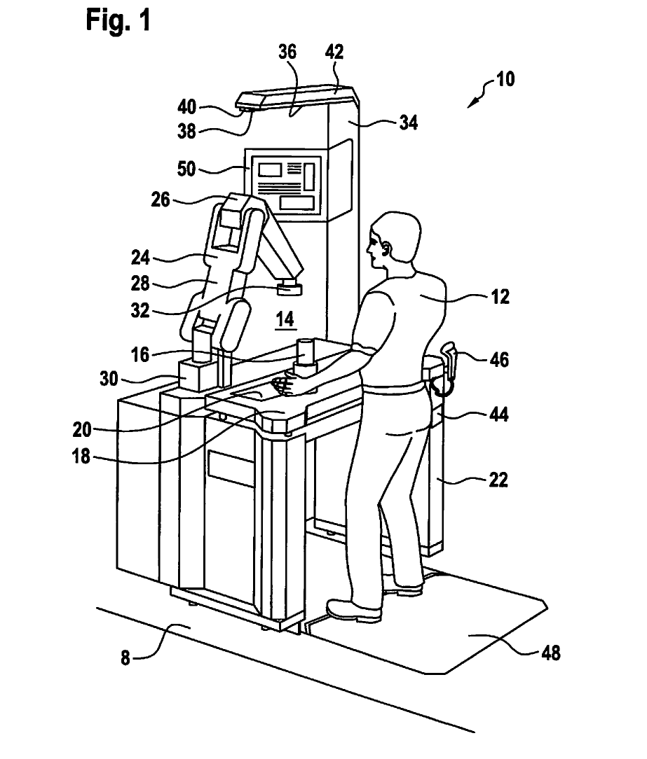

FIG. 1 shows a general view of a manual work station 10. Manual work station 10 includes a base frame 22 on which the additional components of manual work station 10 are mounted. Base frame 22 stands on a floor 8. A work surface 18 is situated on base frame 22 on which a workpiece 16 is shown in FIG. 1 by way of example. A robotic arm 24 is mounted on the edge of work surface 18. Robotic arm 24 is connected to base frame 22 of manual work station 10 via a robot base 30. Robot base 30 includes a rotary feed-through unit, which is designed in such a way that robotic arm 24 is able to rotate 360° with respect to base frame 22, the rotary feed-through unit at the same time guiding pneumatic, hydraulic and/or electrical lines from base frame 22 to robotic arm 24. Robotic arm 24 is made up of a plurality of stiff arm sections 28, which are connected to one another in a serial arrangement via joints 26. A manipulator 32 is mounted on the end of robotic arm 24. Depending on the respective application, manipulator 32 is developed for example as a mechanical gripper or a suction gripper. Stiff arm sections 28 and joints 26 of robotic arm 24 are covered in skin-like fashion by a multitude of distance sensors in a kind of sensor skin. The distance sensors in the preferred exemplary embodiment are capacitive distance sensors. The distance sensors themselves are preferably covered by a flexible layer, for example leather or artificial leather, which additionally provides mechanical protection for the distance sensors.

Furthermore, a boom 34 is attached on the right side of base frame 22. Boom 34 is an L-shaped beam fastened laterally on base frame 22 that projects upward with the long section of the L-shaped beam and that is positioned with the short section of the L-shaped beam horizontally approximately 2.5 m above floor 8. Approximately 1.8 m above the floor, a screen 50 is attached on the long section of the L-shaped beam. In the preferred exemplary embodiment, screen 50 is a touch-sensitive screen that is oriented toward worker 12. A camera 38 and a projector 40 are attached on the short section of the L-shaped beam of boom 34 on the bottom side facing downward.

Furthermore, work station light 36 is situated on the short section of the L-shaped beam, likewise facing downward. An optical display unit 42 is attached laterally in a circumferential manner on the short section of the L-shaped beam. The optical display unit 42 indicates the current state of manual work station 10 encoded in different colors and/or blinking frequencies. For example, the color green in constant light indicates production operation, while alternatively or additionally a blinking color red indicates a fault. Alternatively or additionally, the state “stop” and/or the state “shortage of material” and/or the state that service is required is/are indicated.

Preferably, camera 38 and/or projector 40 and/or work station light 36 and/or optical display unit 42 are situated in a common housing of boom 34. Manual work station 10 furthermore has a card reader 44 and a reading device for optical codes 46. Reading device for optical codes 46 is designed to scan in product codes that are attached to workpiece parts. Alternatively or additionally, the reading device for optical codes 46 is designed to scan in personal codes for identifying persons and/or for standardizing the work station. In the preferred exemplary embodiment, worker 12 is standing in front of manual work station 10 on a sensorial floor mat 48. In the preferred exemplary embodiment, sensorial floor mat 48 is a rubber mat that has a plurality of pressure sensors such that sensorial floor mat 48 is able to detect whether a worker 12 is standing on sensorial floor mat 48 and/or whether the worker triggers interactions via indicated switching areas. The area reachable by a worker 12 standing in front of the manual work station defines work area 14 of manual work station 10. Work area 14 of manual work station 10 includes in particular work surface 18. Robotic arm 24 likewise has an area defined by the dimensions and movement possibilities of robotic arm 24, which robotic arm 24 is able to reach by manipulator 32. Work area 14 and the area reachable by manipulator 32 of robotic arm 24 intersect such that worker 12 is able to work directly together with robotic arm 24 without protective fences or the like. This is made possible by the sensor skin surrounding sensor arm 24, which detects an approach of worker 12. Even before worker 12 touches robotic arm 24, a control unit stops robotic arm 24, robotic arm 24 continuing the interrupted motion once the hazard area is free again.

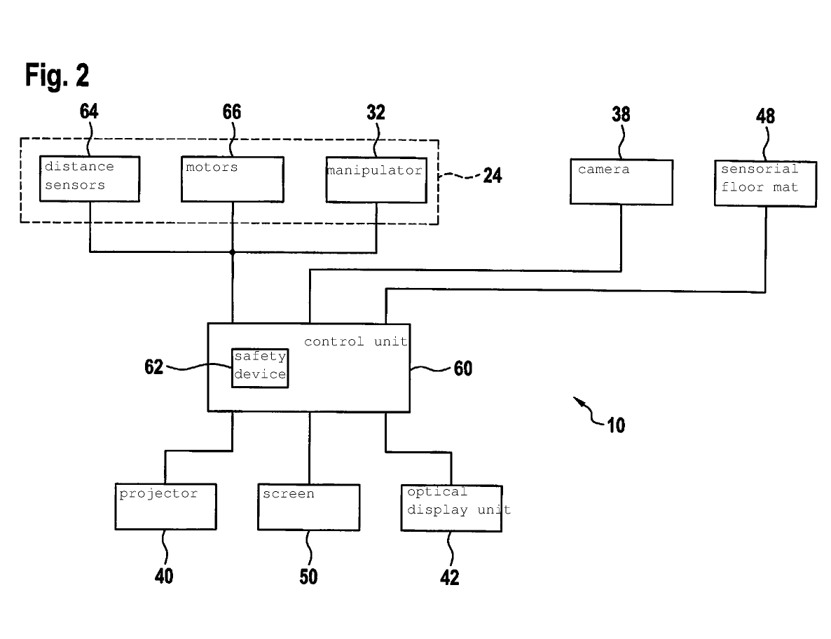

FIG. 2 shows a block diagram of an interactive manual work station 10. In this exemplary embodiment, manual work station 10 is a manual work station for manufacturing. The sequencing of manual work station 10 is controlled by control unit 60. Control unit 60 comprises a safety device 62. In an alternative specific embodiment, safety device 62 is not integrated in control unit 60, but is a separate unit that interacts with control unit 60. Safety device 62 effects a contact-free cooperation of robotic arm 24 of manual work station 10 with a worker in a work area of manual work station 10. Control unit 60 is electrically connected to various components of robotic arm 24.

In particular, control unit 60 is electrically connected to distance sensors 64 of robotic arm 24. Furthermore, control unit 60 is electrically connected to motors 66 in the robot base and in the joints of robotic arm 24. Furthermore, control unit 60 is electrically connected to manipulator 32 of robotic arm 24. Control unit 60 controls robotic arm 24 and manipulator 32 via motors 66 as a function of a control program and/or the sensor data ascertained by distance sensors 64. Control unit 60 is furthermore electrically connected to camera 38 and sensorial floor mat 48 and evaluates the signals of these sensors. Control unit 60 is furthermore electrically connected to projector 40, screen 50 and optical display unit 42. In the preferred exemplary embodiment, control unit 60 controls robotic arm 24 in such a way that robotic arm 24 performs a preassembly of components for a workpiece, a worker performing the final assembly. In an alternative or additional specific embodiment, control unit 60 controls robotic arm 24 in such a way that robotic arm 24 takes workpiece parts from a storage bin and supplies them to the worker. In an alternative or additional specific embodiment, control unit 60 controls robotic arm 24 in such a way that robotic arm 24 performs a precision assembly. In the preferred exemplary embodiment, control unit 60 performs a part recognition as a function of image data of camera 38. As a function of the detected parts, the control unit preferably performs a safeguarding operation against mistaken identification and/or an assembly check of the assembly step performed by the worker, a possibly detected error being indicated to the worker on the work surface as an error on screen 50 and/or via projector 40. In an alternative or additional specific embodiment, control unit 60 performs, as a function of the image data of camera 38, an activity step monitoring of the worker and/or a quality control. In another alternative or additional specific embodiment, control unit 60 performs, as a function of the image data, a gesture detection of movements of the worker, control unit 60 controlling the further assembly sequence as a function of the detected gestures. In the preferred exemplary embodiment, control unit 60 performs an evaluation of the data produced by the sensorial floor mat 48 in such a way that control unit 60 detects whether a worker is present. In an alternative or additional specific embodiment, control unit 60 evaluates the data of floor mat 48 in such a way that the control unit detects an input of the worker via the foot. In the preferred exemplary embodiment, control unit 60 controls projector 40 in such a way that projector 40 indicates instructions and/or support information and/or error arrows and/or markings of parts and/or areas in the work area. In an alternative or additional specific embodiment, control unit 60 controls projector 40 in such a way that projector 40 projects training aids for a training phase of a new worker. In an alternative or additional specific embodiment, control unit 60 controls projector 40 in such a way that projector 40 projects relaxation exercises and/or relaxation games and/or rehabilitation exercises in activity pauses. In the preferred exemplary embodiment, control unit 60 controls screen 50 in such a way that screen 50 displays support information and/or material supplies and/or maintenance information. In an alternative or additional specific embodiment, control unit 60 controls the preferably touch-sensitive screen 50 in such a way that parameters are input and/or other data are queried via screen 50. Control unit 60 performs an interaction with the worker via screen 50. In another alternative or additional specific embodiment, control unit 60 controls screen 50 and/or projector 40 in such a way that interactive training programs for learning assembly steps are carried out by workers.

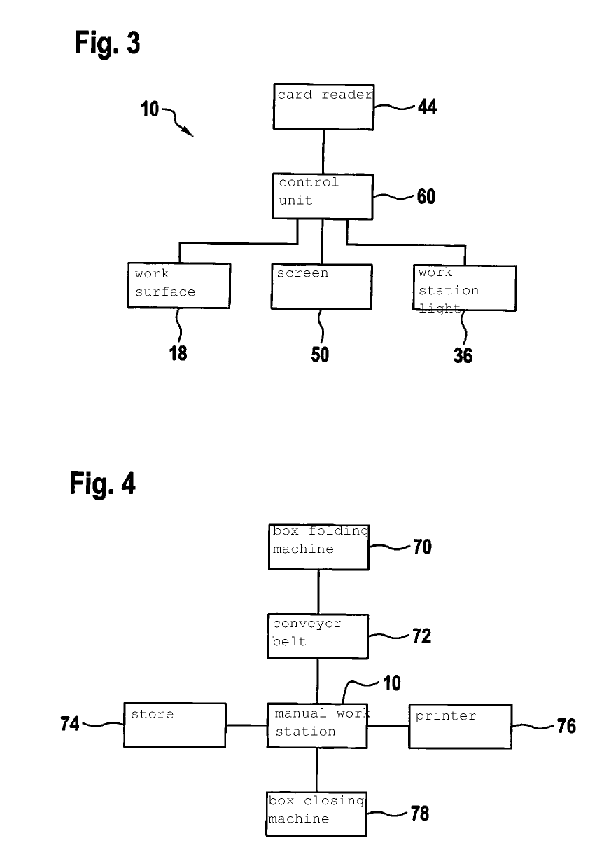

FIG. 3 shows a block diagram of an automatically personalized manual work station 10. In this exemplary embodiment, control unit 60 is connected to a card reader 44 as well as to a work surface 18 and/or a screen 50 and/or a work station light 36 that is/are height-adjustable in a motor-driven manner. Control device 60 ascertains the respective worker as a function of data read in via card reader 44. This occurs in that the worker holds a personal card against card reader 44 which contains an identification that characterizes the worker. As a function of the ascertained worker, manual work station 10 is personalized for the worker. In particular, the control unit performs a language switch and/or the control unit changes the work height of work surface 18 and/or control unit 60 indicates on screen 50 a specified task description and/or control unit 60 adjusts the work station light 36 in accordance with the inputs of the worker.

FIG. 4 shows a block diagram of a manual work station for packaging.

In this exemplary embodiment, manual work station 10 is implemented as a packaging manual work station. A box folding machine 70 produces boxes from a ply of cardboard. The produced boxes are supplied to manual work station 10 via a conveyor belt 72. Using a manipulator, the robotic arm of the manual work station takes parts from a store 74, for example a shelf, scans the codes of the parts using a reading device for optical codes and places the parts in the produced box. This process is repeated until all required parts are located in the box. Upon the conclusion of this process, a printer 76 prints a packing slip as a function of the scanned codes and the worker places the printed packing slip into the box. Alternatively or additionally, a sticker is printed out and is glued onto the box by the worker. A subsequent box closing machine 78 closes the box.

The exemplary embodiments and specific embodiments of a manual work station described above with reference to FIGS. 1 through 4 may be respectively combined with one another.

In one variant of the described exemplary embodiments, two robotic arms are used, one robotic arm being installed to the left of the work area on the manual work station and the second robot arm being fasted to the right of the work area on the manual work station. In another variant, three or four or more than four robotic arms are fastened on the manual work station. In another variant of the described exemplary embodiments, two or more robotic arms are used that are fastened on one side of the work area via a single robot base on the manual work station. In another variant of the described exemplary embodiments, the robotic arm or the robotic arms is/are not fastened on the manual work station, but rather the robotic arm or the robotic arms is/are mounted for example via a ceiling mount from above.

In one variant of the described exemplary embodiments, in addition to a camera that captures images in the visible range, at least one second camera is used. Preferably, this is likewise a camera that captures images in the visible range and essentially covers the same area as the first camera. The two cameras are situated at a distance from each other and form a stereo camera. In another variant, the second camera captures, additionally or alternatively, images in the near-infrared wavelength range and/or in the far-infrared wavelength range. In another variant, alternatively or in addition to the camera, a laser scanner, in particular a 3D laser scanner, is used. Laser scanners have the advantage that they also detect depth information in addition to the two-dimensional image information.

In another variant of the described exemplary embodiments, alternatively or in addition to the distance sensors surrounding the robotic arm, touch-sensitive sensors that surround the robotic arm and/or force-measuring sensors that surround the robotic arm and/or are mounted in the robot base and/or optical sensors that monitor the work space and/or thermal sensors and/or ultrasonic sensors are used. These sensors interact with the safety device in such a way that the safety device effects a reduction in the movement of the robotic arm when the robotic arm approaches an object.

In another variant of the described exemplary embodiments, the control unit has a voice interface via which a microphone is connected to the control unit. This makes it possible for the worker to make voice inputs for controlling the manual work station.

What is claimed is:

1. A manual work station for manufacturing and/or packaging, comprising:
a work area accessible to a worker;
at least one robotic arm; and
a safety device designed in such a way that the robotic arm and the worker cooperate in the work area.

2. The manual work station as recited in claim 1, wherein the work area has a work surface.

3. The manual work station as recited in claim 1, wherein the work surface is adjustable up and down in motor-driven fashion.

4. The manual work station as recited in claim 1, wherein the robotic arm is covered with distance sensors and the distance sensors interact with the safety device in such a way that the safety device effects a reduction in movement of the robotic arm when the robotic arm approaches an object.

5. The manual work station as recited in claim 1, wherein the manual work station has at least one monitoring sensor, the monitoring sensor being situated in such a way that the monitoring sensor covers at least a part of the work area, and wherein the monitoring sensor includes at least one of a camera and a laser scanner.

6. The manual work station as recited in claim 1, wherein the manual workstation has at least one projector, the projector being situated in such a way that a projection area of the projector includes at least a part of the work area.

7. The manual work station as recited in claim 2, wherein at least one part of the work surface is a top light projection surface.

8. The manual work station as recited in claim 1, wherein the manual work station has at least one reading device, the at least one reading device including at least one of: i) at least one card reader, and ii) at least one reading device for optical codes.

9. The manual work station as recited in claim 1, wherein the manual work station has a sensorial floor mat.

10. The manual work station as recited in claim 1, wherein the manual work station has an optical display unit for displaying at least one operating state of the manual work station.

11. The manual work station as recited in claim 10, wherein the optical display unit is situated in a common housing above the work area with the at least one of: i) a camera, ii) at least one projector, iii) an optical display unit, and iv) a work station light.

12. The manual work station as recited in claim 1, wherein the manual work station has at least one touch-sensitive screen.

13. A control unit for controlling the sequencing of a manual work station, the manual work station including a work area accessible to a worker, at least one robotic arm, the control unit at least one of including a safety device and interacting with the safety device, the safety device effecting a cooperation of a robotic arm of the manual work station with a worker in a work area of the manual work station.

14. The control unit as recited in claim 13, further comprising:
a voice interface, via which a microphone may be connected to the control unit.
